(19) United States
(12) Patent Application Publication
(10) Pub. No.: US 2013/0323570 A1
(43) Pub. Date: Dec. 5, 2013

(54) NONAQUEOUS ELECTROLYTE SECONDARY BATTERY

(71) Applicant: Masato Iwanaga, Tokushima (JP)

(72) Inventor: Masato Iwanaga, Tokushima (JP)

(73) Assignee: SANYO ELECTRIC CO., LTD., Moriguchi-shi, Osaka (JP)

(21) Appl. No.: 14/000,352

(22) PCT Filed: Feb. 22, 2012
(86) PCT No.: PCT/JP2012/054248

§ 371 Date: Aug. 19, 2013

(30) Foreign Application Priority Data
Feb. 28, 2011 (JP) 2011-042986

(51) Int. Cl. H01M 2/16

(52) U.S. Cl. CPC H01M 2/1686
USPC 429/145

(57) ABSTRACT

A nonaqueous electrolyte secondary battery has a positive electrode plate containing a positive electrode active material capable of reversibly absorbing and desorbing lithium; a negative electrode plate containing a negative electrode active material capable of reversibly absorbing and desorbing lithium; a separator separating the positive electrode plate and the negative electrode plate; and a nonaqueous electrolyte solution obtained by dissolving a solute in an organic solvent, said solute being composed of a lithium salt. In this battery, a polyolefin microporous membrane is used as the separator formed of a multilayer film having two or more layers and at least one of two surface layers of said polyolefin microporous membrane containing inorganic particles. Thus the nonaqueous electrolyte secondary battery exhibits good low-temperature characteristics, high-temperature storage characteristics and room-temperature cycle characteristics even in cases where hexamethylene diisocyanate is contained in the nonaqueous electrolyte solution.

### TECHNICAL FIELD

The present invention relates to a nonaqueous electrolyte secondary battery, and particularly relates to a nonaqueous electrolyte secondary battery that has excellent high-temperature storage characteristics and cycling characteristics.

### BACKGROUND ART

Nonaqueous electrolyte secondary batteries represented by lithium secondary batteries with a high energy density and high capacity are widely used as a power supply to drive modern portable electronic devices such as cellular phones, portable personal computers, and portable music players and further used as a power supply for hybrid electric vehicles (HEV) and electric vehicles (EV).

As a positive electrode active material in these nonaqueous electrolyte secondary batteries, materials can be used that are capable of reversibly absorbing and desorbing lithium ions, namely, LiCoO₂, LiNiO₂, LiNiₓCo₁₋ₓO₂ (x=0.01 to 0.99), LiMnO₂, LiMn₂O₄, LiNiₓMn_{y}Co_{z}O₂ (x+y+z=1), or LiFePO₄. Such materials may be used alone, or two or more of them may be mixed to be used.

Of these, lithium-cobalt composite oxides and dissimilar metal element-added lithium-cobalt composite oxides are frequently used because they provide various battery characteristics particularly superior to those of batteries using other materials. However, cobalt is expensive, and the existing amount as a resource is small. Therefore, to use these lithium-cobalt composite oxides and dissimilar metal element-added lithium-cobalt composite oxides as a positive electrode active material of a nonaqueous electrolyte secondary battery, a further increase in the performance of the nonaqueous electrolyte secondary battery is desired.

Nonaqueous electrolyte secondary batteries have suffered from problems such as deformation or breakage of the battery and a decrease in capacity or the like associated with decomposition and vaporization of a solvent due to progress of reductive decomposition of the solvent forming a nonaqueous electrolyte caused by repeated charging and discharging. Such decomposition of the solvent tends to be significant particularly in the case where graphite is used for a negative electrode, since an extremely strong reducing power is exhibited.

Therefore, to prevent the reductive decomposition of the solvent on the negative electrode, a technique has been developed in which a compound that forms a coating of a so-called solid electrolyte interface (SEI) on the negative electrode is added to the electrolyte in advance.

For example, Patent Document 1 discloses an invention of a nonaqueous electrolyte secondary battery in which decomposition of a solvent and deformation of a battery is prevented by SEI formed in the initial period of use while maintaining and improving the battery characteristics and long-term storage reliability by using a diisocyanate compound in an electrolyte of a battery including lithium as an electrolyte salt.

Patent Document 2 discloses, as a separator that improves the properties of a nonaqueous electrolyte such as the impregnating properties, mechanical strength, permeability, and high-temperature storage characteristics when used in a battery, a separator that is a polyolefin microporous membrane including polyethylene and polypropylene and formed of a multilayer film having two or more layers. In the separator disclosed, at least a surface layer on one side includes inorganic particles, and the polypropylene content is 5% by mass or greater and 90% by or less.

### RELATED ART DOCUMENTS

### Patent Documents

Patent Document 1: JP-A-2007-242411
Patent Document 2: WO 2006/038532

### DISCLOSURE OF INVENTION

### Problem to be Solved by the Invention

With the invention disclosed in the patent document 1 described above, it is possible to prevent decomposition of the solvent and deformation of the battery by using a diisocyanate compound in the electrolyte, since a stable SEI is formed on the negative electrode by charging in the initial period of use.

However, while an improvement in cycling characteristics and storage characteristics has been seen when hexamethylene diisocyanate, which is a diisocyanate compound, is added in a nonaqueous electrolyte, a problem has been found of a decrease in low-temperature characteristics, specifically, a decrease in charge-discharge capacity under a low-temperature environment.

Patent Document 2 does not mention anything about a case where a battery with an electrolyte containing a diisocyanate compound includes as a separator a polyolefin microporous membrane that is formed of a multilayer film having two or more layers and in which at least a surface layer on one side includes inorganic particles. There is no suggestion of the effect on a decrease in low-temperature characteristics and the like in the case of using a polyolefin microporous membrane including inorganic particles as a separator in a battery with an electrolyte containing hexamethylene diisocyanate.

The inventor of the present invention has conducted various studies on the conditions in which a decrease in low-temperature characteristics do not occur even when a nonaqueous electrolyte contains hexamethylene diisocyanate for improvement of the cycling characteristics and storage characteristics. As a result, the inventor has found that a decrease in low-temperature characteristics due to the addition of hexamethylene diisocyanate does not occur when a polyolefin microporous membrane including a layer containing inorganic particles is used as a separator, and the high-temperature storage characteristics, the room-temperature cycling characteristics, and the low-temperature characteristics improve overall. The inventor has thus completed the present invention.

That is, an object of the present invention is to obtain a nonaqueous electrolyte secondary battery that has good high-temperature storage characteristics and room-temperature cycling characteristics without a decrease in the low-temperature characteristics, even in the case where hexamethylene diisocyanate is contained in a nonaqueous electrolyte.

### Means for Solving Problem

To achieve the object described above, a nonaqueous electrolyte secondary battery of the present invention includes: a positive electrode plate and a negative electrode plate that contain a material capable of reversibly absorbing and desorbing lithium; a separator separating the positive electrode plate and the negative electrode plate from each other; and a nonaqueous electrolyte that is obtained by dissolving a solute composed of a lithium salt in an organic solvent. In the nonaqueous electrolyte secondary battery, the nonaqueous electrolyte contains hexamethylene diisocyanate, the separator is a polyolefin microporous membrane formed of a multilayer film having two or more layers, and at least one of two surface layers contains inorganic particles.

With the nonaqueous electrolyte secondary battery of the present invention, a nonaqueous electrolyte secondary battery can be obtained in which a decrease in the low-temperature characteristics that can occur by the addition of hexamethylene diisocyanate is prevented and the high-temperature storage characteristics and the room-temperature cycling characteristics are improved, by adding hexamethylene diisocyanate in the nonaqueous electrolyte and using the microporous membrane formed of a plurality of layers and containing inorganic particles in at least one of the two surface layers as the separator.

In the present invention, the polyolefin microporous membrane used as the separator preferably contains polyethylene for its excellent permeability and shutdown characteristics as the separator. The effect described above of the present invention is obtained if the content of the inorganic particles contained in the separator surface layer is 5% by mass or greater, and it is possible to improve the high-temperature storage characteristics and the room-temperature cycling characteristics without a decrease in the low-temperature characteristics even in the case where the concentration of the hexamethylene diisocyanate contained in the nonaqueous electrolyte is 6.0% by mass.

Meanwhile, as suggested in Patent Document 2 described above, there is a risk of causing a disadvantage in terms of mechanical strength or membrane formation of the separator when the content of the inorganic particles included in the separator surface layer is excessive. The content of the inorganic particles is therefore preferably 40% by mass or less. As the inorganic particles to be contained, at least any of an oxide or a nitride of silicon, aluminum, and titanium is preferably used, and silicon dioxide and aluminum oxide is more preferable.

The effect of the present invention described above can be obtained if the concentration of the hexamethylene diisocyanate contained in the nonaqueous electrolyte is 0.1% by mass or greater. As long as the concentration of the hexamethylene diisocyanate is not excessively high, an improvement effect can be obtained not only in the high-temperature storage characteristics and the room-temperature cycling characteristics but also in the low-temperature characteristics. In contrast, in the case where the hexamethylene diisocyanate concentration is excessively high, there is a risk that a decrease in the low-temperature characteristics due to the addition of hexamethylene diisocyanate is not prevented sufficiently. The concentration of the hexamethylene diisocyanate is therefore preferably 6.0% by mass or less and more preferably 4.0% by mass or less.

The positive electrode active material that can be used in the nonaqueous electrolyte secondary battery of the invention is not limited in any way as long as it is a material that is capable of reversibly absorbing and desorbing lithium ions, and may be a positive electrode active material as mentioned above that is conventionally in common use. The negative electrode active material that can be used in the nonaqueous electrolyte secondary battery of the invention is not limited in any way as long as it is a material that is capable of reversibly absorbing and desorbing lithium ions. Examples of the negative electrode active material include: a carbon raw material such as graphite, non-graphitizable carbon, and graphitizable carbon; a titanium oxide such as LiTiO₂ and TiO₂; a metalloid element such as silicon and tin; and a Sn—Co alloy.

Examples of a nonaqueous solvent that can be used for the nonaqueous electrolyte secondary battery of the invention include: a cyclic carbonate such as ethylene carbonate (EC), propylene carbonate (PC), and butylene carbonate (BC); a fluorinated cyclic carbonate; a cyclic carboxylic ester such as γ-butyrolactone (γ-BL) and γ-valerolactone (γ-VL); a chain carbonate such as dimethyl carbonate (DMC), ethyl methyl carbonate (EMC), diethyl carbonate (DEC), methylpropyl carbonate (MPC), and dibutyl carbonate (DBC); a fluorinated chain carbonate; a chain carboxylic ester such as methyl pivalate, ethyl pivalate, methyl isobutyrate, and methyl propionate; an amide compound such as N,N′-dimethylformamide and N-methyl oxazolidinone; a sulfur compound such as sulfolane; and an ambient-temperature molten salt such as 1-ethyl-3-methylimidazolium tetrafluoroboric acid. It is desirable that two or more of them be mixed to be used. Of these, preferred are a cyclic carbonate ester and a chain carbonate ester that have a particularly large permittivity and large nonaqueous electrolyte ion conductivity.

Within the nonaqueous electrolyte used in the nonaqueous electrolyte secondary battery of the invention, the following compounds may be further added as compounds for stabilization of electrodes: vinylene carbonate (VC), vinyl ethyl carbonate (VEC), succinic anhydride (SUCAH), maleic anhydride (MAAH), glycolic anhydride, ethylene sulfite (ES), divinyl sulfone (VS), vinyl acetate (VA), vinyl pivalate (VP), catechol carbonate, and biphenyl (BP). Two or more of these compounds can also be mixed for use as appropriate.

In the nonaqueous electrolyte secondary battery of the invention, a lithium salt that is commonly used as an electrolyte salt for a nonaqueous electrolyte secondary battery may be used as an electrolyte salt dissolved in the nonaqueous solvent. Examples of such a lithium salt are as follows: LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures of these substances. In particular, among them, it is preferable that LiPF₆ (lithium hexafluorophosphate) be used. The amount of dissolution of the electrolyte salt with respect to the nonaqueous solvent is preferably from 0.5 to 2.0 mol/L.

In the nonaqueous electrolyte secondary battery of the invention, the nonaqueous electrolyte may be not only in liquid form but also in gel.

### BEST MODE(S) FOR CARRYING OUT THE INVENTION

An embodiment for carrying out the present invention will be described below in detail using each example and comparative example. The examples below show examples of a nonaqueous electrolyte secondary battery for embodying the technical idea of the present invention and is not intended to specify the present invention as the examples. The present invention is equally applicable to various modifications without departing from the technical idea shown in the scope of claims.

First, a specific manufacturing method of a nonaqueous electrolyte secondary battery according to each example and comparative example will be described.

### [Positive Electrode Active Material]

For a positive electrode active material, lithium cobalt oxide in which erbium trihydroxide adhered on the surface was used. The active material was prepared in the following manner Lithium carbonate (Li₂CO₃) was used for a lithium source as a starting material, and tricobalt tetroxide (Co₃O₄) was used as a cobalt source. These materials were weighed and mixed so that the molar ratio was 1:1, and the mixture was baked for 24 hours at 850° C. under an air atmosphere to obtain lithium cobalt oxide. The lithium cobalt oxide thus obtained was pulverized with a mortar to an average particle diameter of 15 μm, and 1000 g thereof was added to 3 liters of pure water and stirred to prepare a suspension in which the lithium cobalt oxide was dispersed. To the suspension, an aqueous solution was added in which 4.53 g of Erbium(III) nitrate pentahydrate (Er(NO₃)₃.5H₂O) was dissolved, so as to be contained at 0.1 mol % with respect to the lithium cobalt oxide in terms of erbium element. In adding the aqueous solution to the suspension, the pH of the suspension was held at 9 by further adding 10% by mass of sodium hydroxide aqueous solution. Next, the resultant object was filtered under reduced pressure and then washed with water, and a powder thus obtained was dried at 120° C. Thereby, the lithium cobalt oxide having the surface with erbium trihydroxide adhering uniformly thereon was obtained. Subsequently, by thermal treatment of the lithium cobalt oxide to which erbium trihydroxide adhered in air for 5 hours at 300° C., the positive electrode active material used commonly in the nonaqueous electrolyte secondary battery of each example and comparative example was obtained.

[Preparation of Positive Electrode Plate]

A slurry was prepared by mixing 94 parts by mass of the positive electrode active material obtained in the manner described above, 3 parts by mass of carbon powder as a conducting agent, and 3 parts by mass of polyvinylidene fluoride (PVdF) powder as a binding agent, and mixing the mixture with an N-methylpyrrolidone (NMP) solution. This slurry was applied by the doctor blade method to both surfaces of a positive electrode collector formed of aluminum with a thickness of 15 μm and then dried to form an active material layer on both surfaces of the positive electrode collector. Next, through compression using a compression roller, a positive electrode plate used commonly in the nonaqueous electrolyte secondary battery of each example and comparative example was obtained.

[Preparation of Negative Electrode Plate]

A slurry was prepared by dispersing 96 parts by mass of graphite powder as a negative electrode active material, 2 part by mass of carboxymethyl cellulose as a thickening agent, and 2 parts by mass of styrene-butadiene rubber (SBR) as a binding agent into water. This slurry was applied by the doctor blade method to both surfaces of a negative electrode collector formed of copper with a thickness of 8 μm and then dried to form an active material layer on both surfaces of the negative electrode collector. Next, through compression using a compression roller, a negative electrode plate used commonly in the nonaqueous electrolyte secondary battery of each example and comparative example was obtained.

The potential of graphite is 0.1 V relative to lithium as the reference. The amount of active material filling of the positive electrode plate and the negative electrode plate was adjusted such that the charge capacity ratio (the ratio of the negative electrode charge capacity to the positive electrode charge capacity) of the positive electrode plate and the negative electrode plate is 1.1 at the potential of the positive electrode active material that is the design reference.

### Preparation of Nonaqueous Electrolyte

### Examples 1 and 5 and Comparative Example 3

A nonaqueous electrolyte used in a nonaqueous electrolyte secondary battery of Examples 1 and 5 and Comparative Example 3 was prepared by adding 2% by mass of vinylene carbonate (VC), 1% by mass of adiponitrile, and 0.5% by mass of hexamethylene diisocyanate (HDMI) to an electrolyte. In the electrolyte, 1.2 mol/L of LiPF₆ was dissolved in a mixed solvent in which monofluoroethylene carbonate (FEC), ethylene carbonate (EC), propylene carbonate (PC), methyl ethyl carbonate (MEC), and diethyl carbonate (DEC) were mixed such that the volume ratio was 15:10:5:35:35.

### Examples 2 to 4 and Comparative Examples 1, 2, and 4

In Examples 2 to 4 and Comparative Examples 1, 2, and 4, a nonaqueous electrolyte was prepared in a similar manner to Examples 1 and 5 and Comparative Example 3, except that the additive amount of hexamethylene diisocyanate was changed. The additive amount of hexamethylene diisocyanate was 0.1% by mass in Example 2 and Comparative Example 2, 4.0% by mass in Example 3, 6.0% by mass in Example 4, and 0.0% by mass (that is, without addition of hexamethylene diisocyanate) in Comparative Examples 1 and 4.

### Preparation of Separator

### Examples 1 to 4 and Comparative Example 4

A three-layer polyethylene microporous membrane was used as a separator. A raw material for two layers corresponding to the surface was prepared in such a manner that polyethylene and silicon dioxide (SiO₂) as inorganic particles were mixed in a proportion of 86:14 in mass ratio and stirred with a mixer. A raw material for an intermediate layer sandwiched between the two surface layers described above was polyethylene. The raw materials of the surface layers and the intermediate layer were each kneaded with liquid paraffin as a plasticizing agent, and then formed into a sheet shape having three layers using a co-extrusion method while kneading and heat-melting each layer for a separator in which a layer containing inorganic particles was arranged as the surface layer on both sides. Subsequently, the resultant object was stretched, and the plasticizing agent was extracted and removed. By drying and stretching the resultant object, a three-layer polyethylene microporous membrane of which the two surface layers were each 2 μm and the intermediate layer was 10 μm was prepared as the separator used in Examples 1 to 4 and Comparative Example 4.

### Example 5

A three-layer polyethylene microporous membrane as a separator used in the nonaqueous electrolyte secondary battery of Example 5 was prepared in a similar manner to Examples 1 to 4 and Comparative Example 4, except that the mixture proportion (mass ratio) of polyethylene of the layer containing inorganic particles and silicon dioxide (SiO₂) as inorganic particles was changed to 95:5.

### Comparative Examples 1 to 3

A separator used in the nonaqueous electrolyte secondary battery of Comparative Examples 1 to 3 was prepared using a co-extrusion method while heat-melting after kneading polyethylene as a raw material with liquid paraffin as a plasticizing agent. The separator does not contain inorganic particles and has a single layer structure of polyethylene.

[Preparation of Battery]

The positive electrode plate and the negative electrode plate described above were wound with the separator corresponding to each example and comparative example therebetween to form a wound electrode assembly. After the wound electrode assembly was accommodated in a metal cylindrical outer can, the electrolyte corresponding to each example and comparative example was poured therein to prepare a cylindrical nonaqueous electrolyte secondary battery according to each example and comparative example. The design capacity of the obtained nonaqueous electrolyte secondary battery is 2900 mAh with the charging voltage at 4.35 V.

[Evaluation of Room-Temperature Cycling Characteristics]

The battery of each example and comparative example prepared in a manner described above was charged under an environment of 25° C. with a constant current of 0.8 It that equals 2.32 A until the battery voltage reached 4.35 V (4.45 V in positive electrode potential with lithium as a reference). After the battery voltage reached 4.35 V, each battery was charged with a constant voltage of 4.35 V until the charging current reached 1/50 It that equals 58 mA to obtain a battery in a fully charged state. Subsequently, discharge was performed with a constant current of 1 It that equals 2.9 A until the battery voltage reached 3.0 V. With this charge and discharge as one cycle, the discharge capacity on the 1st cycle was measured.

The charge and discharge described above were repeated, the discharge capacity on the 300th cycle was measured, and the room-temperature cycle capacity retention rate was obtained from a formula below. The room-temperature cycling characteristics were evaluated with the room-temperature cycle capacity retention rate being 80% or greater as “A”, 75% or greater and less than 80% as “B”, and less than 75% as “C”.

Room-temperature cycle capacity retention rate (%)=(Discharge capacity on 300th cycle)/(Discharge capacity on 1st cycle)×100

[Evaluation of Low-Temperature Characteristics]

A total of 4 cycles of charge and discharge was performed consecutively to the battery of each example and comparative example with 1 cycle under an environment of 25° C. and 3 cycles under an environment of 0° C. without changing the condition of voltage and current upon evaluation of the room-temperature cycling characteristics and charge and discharge described above. In this process, the discharge capacity on the 1st cycle and the discharge capacity on the 4th cycle were measured to obtain the low-temperature discharge capacity rate from a formula below. The low-temperature characteristics were evaluated with the low-temperature discharge capacity rate being 70% or greater as “A”, 60% or greater and less than 70% as “B”, and less than 60% as “C”.

Low-temperature discharge capacity rate (%)=(Discharge capacity on 4th cycle)/(Discharge capacity on 1st cycle)×100

[Evaluation of High-Temperature Storage Characteristics]

The battery of each example and comparative example was charged under an environment of 25° C. with a constant current of 1 It that equals 2.9 A until the battery voltage reached 4.35 V (4.45 V in positive electrode potential with lithium as a reference). After the battery voltage reached 4.35 V, each battery was charged with a constant voltage of 4.35 V until the charging current reached 1/50 It that equals 58 mA to obtain a battery in a fully charged state. Subsequently, discharging was performed with a constant current of 1 It that equals 2.9 A until the battery voltage reached 3.0 V, and the discharge capacity was measured as the pre-storage capacity.

Subsequently, each battery was charged with a constant current of 1 It that equals 2.9 A under an environment of 25° C. After the battery voltage reached 4.35 V, each battery was charged with a constant voltage of 4.35 V until the charging current reached 1/50 It that equals 58 mA to obtain a battery in a fully charged state. Subsequently, each of the batteries in the fully charged state was stored for 20 days in a thermostatic chamber maintained at 60° C. Each battery after 20 days of storage was cooled until the battery temperature reached 25° C., and then discharge was performed with a constant current of 1 It that equals 2.9 A until the battery voltage reached 3 V. The residual capacity was obtained from a formula below with the discharge capacity at this time as the post-storage capacity. The high-temperature storage characteristics were evaluated with the residual capacity being 80% or greater as “A”, 75% or greater and less than 80% as “B”, and less than 75% as “C”.

Residual capacity (%)=(Post-storage capacity)/(Pre-storage capacity)×100

The evaluation results of the room-temperature cycling characteristics, the low-temperature characteristics, and the high-temperature storage characteristics obtained in a manner described above are summarized and shown in Table 1.

TABLE 1

| | Inorganic | | | | |
|---|---|---|---|---|---|
| | substance | HMDI addive | | | |
| | additive | amount in the | High- | Room- | |
| | amount in the | nonaqueous | temperature | temperature | Low- |
| | separator | electrolyte | storage | cycling | temperature |
| | (% by mass) | (% by mass) | characteristics | characteristics | characteristics |
| Example 1 | 14 | 0.5 | A | A | A |
| Example 2 | 14 | 0.1 | A | A | A |
| Example 3 | 14 | 4.0 | A | A | A |
| Example 4 | 14 | 6.0 | A | A | B |
| Example 5 | 5 | 0.5 | A | A | A |
| Comparative | 0 | 0.0 | B | B | B |
| Example 1 | | | | | |
| Comparative | 0 | 0.1 | A | B | B |
| Example 2 | | | | | |
| Comparative | 0 | 0.5 | A | B | C |
| Example 3 | | | | | |
| Comparative | 14 | 0.0 | B | B | B |
| Example 4 | | | | | |

The following can be seen from Table 1. That is, the results of Comparative Examples 1 to 3 show that, while an improvement is seen in the high-temperature storage characteristics, the low-temperature characteristics decrease by adding hexamethylene diisocyanate to the electrolyte in the case where the microporous membrane with the surface layer containing no inorganic particles is used as the separator.

The results of Comparative Example 1 and Comparative Example 4 show that no significant difference is seen in the high-temperature storage characteristics, the room-temperature cycling characteristics, or the low-temperature characteristics associated with the microporous membrane used as the separator between a case where the microporous membrane in which the surface layer contains inorganic particles is used and a case where the microporous membrane in which the surface layer does not contain inorganic particles is used.

The results of Example 1 and Comparative Example 3 will be compared, to both of which 0.5% by mass of hexamethylene diisocyanate was added. All of the high-temperature storage characteristics, the room-temperature cycling characteristics, and the low-temperature characteristics improved in Example 1, whereas a decrease occurred in the low-temperature characteristics in exchange for an improvement in the high-temperature storage characteristics in Comparative Example 3 relative to Comparative Example 1.

Furthermore, the results of Example 4 show that a decrease in the low-temperature characteristics is not seen and the high-temperature storage characteristics and the room-temperature cycling characteristics improved regardless of hexamethylene diisocyanate being added 10 times or more (6.0% by mass) with respect to Comparative Example 3.

An effect of improving the room-temperature cycling characteristics and the low-temperature characteristics is not seen in the case where hexamethylene diisocyanate was merely added to the nonaqueous electrolyte (Comparative Examples 2 and 3) or in the case where the microporous membrane in which the surface layer contains inorganic particles is merely used as the separator (Comparative Example 4). Such an improving effect can be achieved through the addition of hexamethylene diisocyanate in the nonaqueous electrolyte and the use of, as the separator, the microporous membrane formed of a plurality of layers and having the layer containing inorganic particles at the surface. That is, a configuration according to the present invention provides a synergetic effect of not only significantly preventing a decrease in the low-temperature characteristics due to the addition of hexamethylene diisocyanate that has been known conventionally, but also entirely improving the high-temperature storage characteristics and the room-temperature cycling characteristics.

The effect described above is presumably based on the following mechanism. That is, it is presumed that inorganic substance in the separator between the positive electrode plate and the negative electrode plate prevents hexamethylene diisocyanate from excessively polymerizing to increase in molecular weight. A considerable increase in viscosity of the electrolyte is prevented as a result.

The results of Example 2 and Comparative Example 2 will be compared, to both of which 0.1% by mass of hexamethylene diisocyanate was added. All of the high-temperature storage characteristics, the room-temperature cycling characteristics, and the low-temperature characteristics improved in Example 2, whereas an improvement in only the high-temperature storage characteristics was seen in Comparative Example 2 relative to Comparative Example 1. It can be seen that the effect described above can be obtained if the additive amount of hexamethylene diisocyanate in the nonaqueous electrolyte is 0.1% by mass or greater.

Meanwhile, an improvement in the low-temperature characteristics is not seen in Example 4, which suggests the prevention effect for a decrease in the low-temperature characteristics could be insufficient in the case where the additive amount of hexamethylene diisocyanate is excessive even if the microporous membrane in which the surface layer contains inorganic particles is used as the separator. It is therefore presumed that the additive amount of hexamethylene diisocyanate is preferably 6% by mass or less. In particular, the additive amount of hexamethylene diisocyanate is preferably 0.1% by mass or greater and 4.0% by mass and less, since an improvement not only in the high-temperature storage characteristics and room-temperature cycling characteristics but also in the low-temperature characteristics is seen in Examples 1 to 3.

The high-temperature storage characteristics, the room-temperature cycling characteristics, and the low-temperature characteristics improved in Example 5 similarly to Example 1. It can be seen that the effect described above can be obtained if the content of inorganic particles in an inorganic particle-containing layer formed on a microporous membrane surface is 5% by mass or greater.

In the example described above, the two surface layers both contain inorganic substance in a three-layer structure due to the membrane formation process. However, it is presumed that the effect described above can be obtained even with a configuration in which only one surface layer contains inorganic substance, since polymerization of hexamethylene diisocyanate is prevented in at least one of the positive electrode side and the negative electrode side in principle. It is more preferable to use a microporous membrane containing the same amount of inorganic particles at the two surface layers as the separator, since warpage of the separator is prevented in the processing of battery assembly. The rigidity of the separator increases when the content of inorganic particles in the surface layer is excessive, and the productivity decreases due to the separator being easily entangled with equipment at the time of winding. Therefore, the content of inorganic particles in the surface layer is preferably 40% by mass or less.

In the nonaqueous electrolyte secondary battery of the examples described above, lithium cobalt oxide including erbium as a dissimilar element is used as the positive electrode active material. However, the present invention is equally applicable not only to a case of use of dissimilar element-added lithium cobalt oxide using an element other than erbium as a dissimilar element, but also to a case of LiCoO₂, LiNiO₂, LiNiₓCo₁₋ₓO₂ (x=0.01 to 0.99), LiMnO₂, LiMn₂O₄, LiNiₓMn_{y}Co_{z}O₂ (x+y+z=1), LiFePO₄, or the like that is conventionally in common use and capable of reversibly absorbing and desorbing lithium.

In the examples described above, silicon dioxide is used for inorganic particles to be contained in the surface layer of the separator. However, a material having insulating properties and less likely to react with a nonaqueous electrolyte can be used. As inorganic particles to be contained, oxide or nitride of silicon, aluminum, and titanium can also be used. Of these, silicon dioxide and aluminum oxide are preferable.

The prismatic nonaqueous electrolyte secondary battery using a flat-shaped wound electrode assembly has been shown as an example in the examples described above. However, the present invention does not depend on the shape of the electrode assembly of the nonaqueous electrolyte secondary battery. Therefore, the present invention is also applicable to a nonaqueous electrolyte secondary battery of a cylindrical shape or an oval shape using a wound electrode assembly or a stacked nonaqueous electrolyte secondary battery in which a positive electrode plate and a negative electrode plate are stacked with a separator therebetween.

1. A nonaqueous electrolyte secondary battery comprising:
a positive electrode plate containing a positive electrode active material capable of reversibly absorbing and desorbing lithium;
a negative electrode plate containing a negative electrode active material capable of reversibly absorbing and desorbing lithium;
a separator separating the positive electrode plate and the negative electrode plate from each other; and
a nonaqueous electrolyte that is obtained by dissolving a solute composed of a lithium salt in an organic solvent,
the nonaqueous electrolyte containing hexamethylene diisocyanate,
the separator being a polyolefin microporous membrane formed of a multilayer film having two or more layers, and
at least one of two surface layers of the separator containing inorganic particles.

2. The nonaqueous electrolyte secondary battery according to claim 1, wherein the separator contains the inorganic particles in both of the two surface layers.

3. The nonaqueous electrolyte secondary battery according to claim 1, wherein the content of the inorganic particles contained in the surface layer is 5% by mass or greater and 40% by mass or less.

4. The nonaqueous electrolyte secondary battery according to claim 1, wherein the content of the hexamethylene diisocyanate contained in the nonaqueous electrolyte is 0.1% by mass or greater and 6.0% by mass or less.

5. The nonaqueous electrolyte secondary battery according to claim 1, wherein the content of the hexamethylene diisocyanate contained in the nonaqueous electrolyte is 0.1% by mass or greater and 4.0% by mass or less.
